(19) United States
(12) Patent Application Publication
(10) Pub. No.: US 2006/0278617 A1
(43) Pub. Date: Dec. 14, 2006

(54) Laser welding of battery module enclosure components

(75) Inventors: Satish Anantharaman, Rochester, MI (US); Gerardus Cornelius Zwegers, Rochester Hills (CA)

Correspondence Address: HARNESS, DICKEY & PIERCE, P.L.C., P.O. BOX 828, BLOOMFIELD HILLS, MI, 48303, US

(73) Assignee: Cobasys, LLC

(21) Appl. No.: 11/233,253

(22) Filed: Sep. 22, 2005

Related U.S. Application Data
(60) Provisional application No. 60/689,675, filed on Jun. 10, 2005.

(51) Int. Cl. B23K 31/02; B23K 26/00

(52) U.S. Cl. 219/121.63; 228/179.1

(57) ABSTRACT

A through transmission laser welding system for a battery module enclosure includes a first battery module enclosure component. A second battery module enclosure component interfaces with the first battery module enclosure component. A laser source focuses a laser beam on a junction between the first and second battery module enclosure components in order to form a weld between the first and second battery module enclosure components. The first and second battery module enclosure components comprise polymeric thermoplastics. The first battery module enclosure component is transmissive to a wavelength of the laser beam and the second battery module enclosure component is opaque to a wavelength of the laser beam. Alternatively, both the first and second battery module enclosure components are transmissive to a wavelength of the laser beam, and a laser absorbing coating is applied at an interface between the first and second battery module enclosure components.

### CROSS-REFERENCE TO RELATED APPLICATIONS

This application claims the benefit of U.S. Provisional Application No. 60/689,675, filed on Jun. 10, 2005, which is hereby incorporated by reference in its entirety.

### FIELD OF THE INVENTION

The present invention relates to welding of thermoplastic components, and more particularly to welding of thermoplastic components used in battery module enclosures.

### BACKGROUND OF THE INVENTION

Battery module enclosures house one or more battery cells that are utilized to provide electrical power. For example, a battery module enclosure may include multiple battery cells connected in series to provide a desired voltage. In some cases, the battery cells comprise liquid materials such as potassium hydroxide and require airtight sealing from an exterior of the battery module as well as between individual cells to prevent a short-circuit condition. Additionally, the battery modules are often utilized in physically unstable environments such as vehicles for hybrid electric applications. Therefore, battery module enclosures commonly comprise thermoplastic materials such as polymeric blends. Since the battery module enclosures typically include at least two interfacing components, welding is often required to create a seal between the multiple components.

In one approach, hot tool welding is utilized to weld thermoplastic components. Hot tool welding involves bringing heated plates in direct or close contact with two or more plastic components in order to generate sufficient heat to create a weld. Since hot tool welding does not involve direct movement of the plastic components, there is a high degree of control over the finished dimensions of the welded assembly. Additionally, hot tool welding does not contribute to flash or particulate generation. However, hot tool welding has a very long cycle time, which increases the duration of welding processes. Additionally, the plates in hot tool welding reach very high temperatures and are in direct or close contact with the surfaces of battery module enclosures. In other words, the applied heat necessary to generate welds is not well focused. Therefore, electronic or other components inside of the battery module enclosure than may be sensitive to high temperatures can be damaged during welding.

In another approach, ultrasonic or friction welding are utilized to generate welds between plastic components. Friction welding involves vibrating plastic components at high intensities in order to generate sufficient heat to create welds between the components. Ultrasonic welding produces a similar result by emitting ultrasonic waves in order to produce the vibration. In either case, the plastic components are moved relative to each other at high speeds in order to create heat from friction. Ultrasonic or friction welding are relatively high speed processes and may be utilized with many thermoplastic materials. However, electronic or other components housed in battery module enclosures are subjected to intense stresses from vibration during ultrasonic or friction welding. Since at least one component is moved relative to the other, it is difficult to control the final dimensions of the welded assembly. Additionally, both ultrasonic and friction welding generate flash or particulates from friction that may contaminate battery modules.

### SUMMARY OF THE INVENTION

A through transmission laser welding system for a battery module enclosure according to the present invention includes a first battery module enclosure component. A second battery module enclosure component interfaces with the first battery module enclosure component. A laser source focuses a laser beam on a junction between the first and second battery module enclosure components in order to form a weld between the first and second battery module enclosure components.

In other features, the first and second battery module enclosure components comprise polymeric thermoplastics. A wavelength of the laser beam is between 800 nm and 1100 nm. The first battery module enclosure component is transmissive to a wavelength of the laser beam and the second battery module enclosure component is opaque to a wavelength of the laser beam. Alternatively, both the first and second battery module enclosure components are transmissive to a wavelength of the laser beam, and a laser absorbing coating is applied at an interface between the first and second battery module enclosure components.

In still other features of the invention, the laser source includes a plurality of laser sources that are arranged to continuously illuminate a predetermined area of the junction. A masking curtain is optionally located adjacent to the junction and selectively filters the laser beam. Alternatively, the laser source includes a single laser source that is scanned across the junction in order to form the weld. Alternatively, the laser source includes a single laser source and an optical mirror that disperses the laser beam in order to continuously illuminate a predetermined area of the junction. In this case, a masking curtain is optionally located adjacent to the junction and selectively filters the laser beam. The battery module enclosure houses battery cells for a hybrid electric vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates an exemplary laser welding process for plastic enclosure components of a battery module according to the present invention;

FIG. 2A is a front view of an exemplary single-cell battery module enclosure;

FIG. 2B is a side cross-section of the single-cell battery module enclosure illustrating interfaces between plastic battery module enclosure components;

FIG. 2C is a scaled partial view of FIG. 2B illustrating a weld made between the plastic enclosure components using laser welding;

FIG. 3 illustrates through transmission laser welding (TTLW) of plastic enclosure components including a first component that is transmissive to a wavelength of a laser beam and a second component that is opaque to the wavelength;

FIG. 4 illustrates TTLW of plastic enclosure components including two components that are transmissive to the wavelength of the laser beam with an absorbing layer between the components;

FIG. 5 illustrates TTLW of plastic enclosure components using continuous illumination of the enclosure components by a laser source including multiple laser beams;

FIG. 6 illustrates TTLW of plastic enclosure components using scan heating of the enclosure components by a moving laser source that includes a single laser beam;

FIG. 7 illustrates TTLW of plastic enclosure components using continuous illumination of the enclosure components through a masking curtain; and

FIG. 8 illustrates TTLW of plastic enclosure components using simulated continuous illumination of the enclosure components by a single laser beam that is reflected by an optical mirror.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify similar elements. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

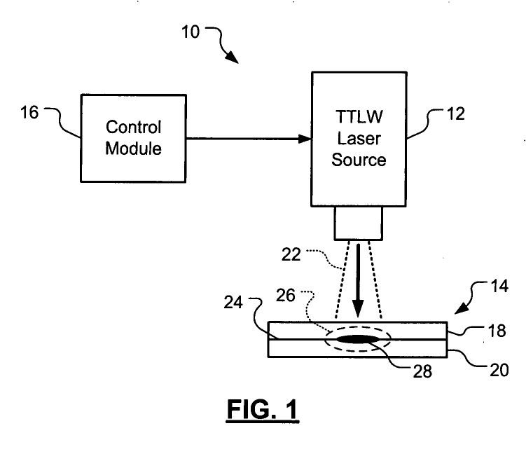

Referring now to FIG. 1, an exemplary through transmission laser welding (TTLW) system 10 according to the present invention includes a laser source 12, a battery module enclosure structure 14, and a control module 16. The control module 16 communicates with the laser source 12 in order to control operation of the laser source 12. For example, the control module 16 may adjust the wavelength or intensity of the laser source 12 as well as the duration of weld processes. A portion 14 of a battery module enclosure includes a first plastic enclosure component 18 that interfaces with a second plastic enclosure component 20. For example, the plastic enclosure components 18 and 20 may comprise thermoplastics such as a polymeric blend or other plastic materials.

The laser source 12 emits a laser beam 22 that is focused at a desired location along a junction 24 between the plastic components 18 and 20. For example, the laser source 12 may include a plurality of laser beams 22 that are utilized to continuously illuminate a desired area, although other laser source configurations are possible as will be further described below. The laser beam 22 heats an isolated portion of the junction 24 between the plastic enclosure components 18 and 20 (as identified by heat zone 26 in FIG. 1), which creates a melt pool 28 that cools and creates a weld when the laser source 12 is turned off.

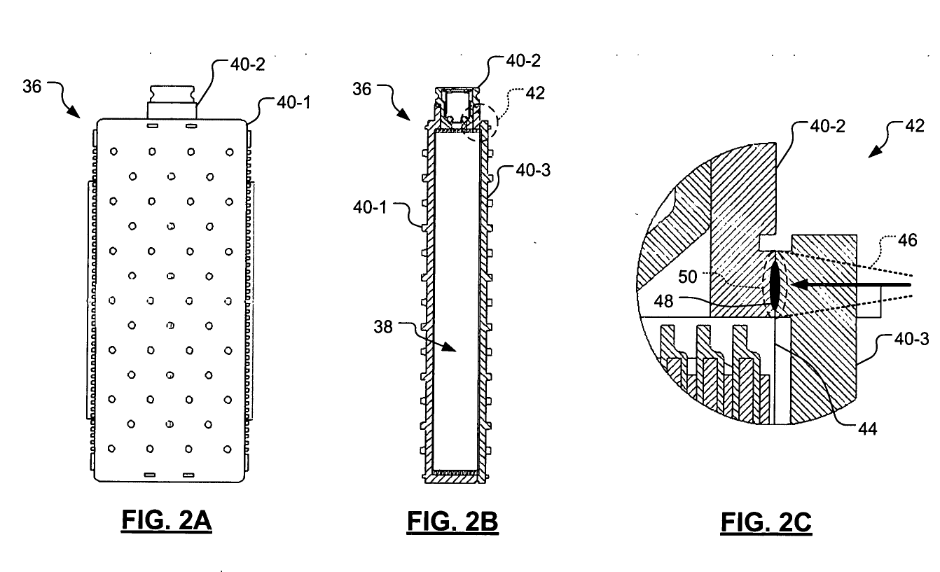

Referring now to FIGS. 2A-2C, an exemplary battery module 36 includes an inner cavity 38 that houses a battery cell. The inner cavity 38 is defined by multiple plastic enclosure components 40 that interface and are welded together along junctions between the plastic enclosure components 40. For example, FIG. 2C illustrates an enlarged view 42 of a junction 44 between side and top plastic enclosure components 40-3 and 40-2, respectively, of the battery module 36. The TTLW process according to the present invention is used to focus a laser beam 46 at the junction 44. A melt pool 48 forms within a heat zone 50, which leaves a structural bond between the plastic enclosure components 40-2 and 40-3 when the laser source 12 is turned off and the melt pool 48 cools.

Since thermoplastics typically have a low conductivity and the laser source 12 has high focusing capabilities, the heat zone 50 is relatively small and presents little risk to components housed in the inner cavity 38. While the battery module 36 illustrated in FIGS. 2A-2C is a single-cell battery module 36, those skilled in the art can appreciate that battery modules 36 may include multiple battery cells that are individually isolated and connected in series.

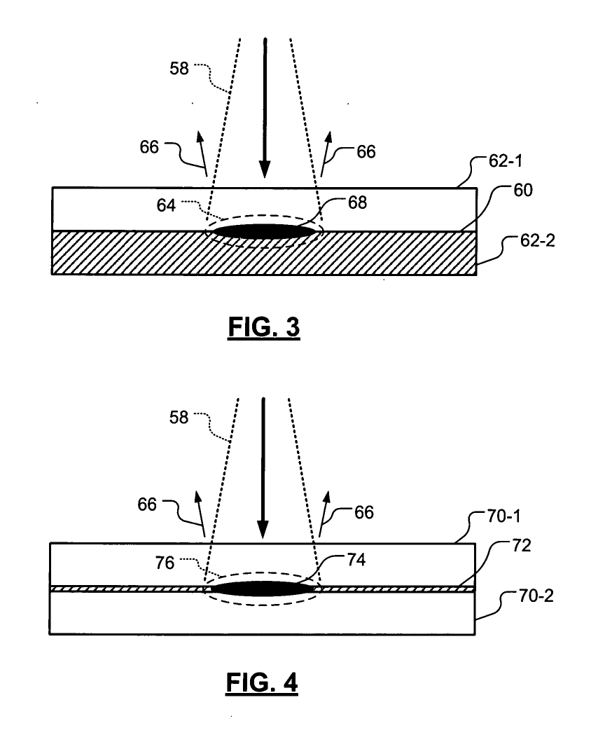

Referring now to FIG. 3, in order for a laser beam 58 to reach a junction 60 between plastic enclosure components 62, at least one of the plastic enclosure components 62-1 and/or 62-2 is transmissive to a wavelength of the laser beam 58. In an exemplary embodiment, the wavelength of the laser beam 58 is between 800 nm and 1100 nm, although other wavelengths are possible. In FIG. 3, a first plastic enclosure component 62-1 is transmissive to the wavelength of the laser beam 58 and a second plastic enclosure component 62-2 is opaque to the wavelength of the laser beam 58. Therefore, the laser beam 58 penetrates the first plastic enclosure component 62-1 to create a heat zone 64 at the junction 60 between the first and second plastic enclosure components 62-1 and 62-2, respectively. Portions 66 of the laser beam 58 are reflected and a melt pool 68 forms within the heat zone 64. The melt pool 68 creates a structural bond between the first and second plastic enclosure components 62-1 and 62-1, respectively, when the laser beam 58 ceases and the melt pool 68 cools.

Referring now to FIG. 4, first and second plastic enclosure components 70-1 and 70-1, respectively, are both transmissive to the wavelength of the laser beam 58. Additionally, an absorbing layer 72 is included between the first and second plastic enclosure components 70-1 and 70-2, respectively. The absorbing layer 72 is opaque to the wavelength of the laser beam 58. Therefore, the laser beam 58 creates a melt pool 74 within a heat zone 76 similarly to the structure illustrated in FIG. 3. The first and second plastic enclosure components 70-1 and 70-2, respectively, preferably comprise similar polymeric blends so that a structurally sound weld is created between the enclosure components 70.

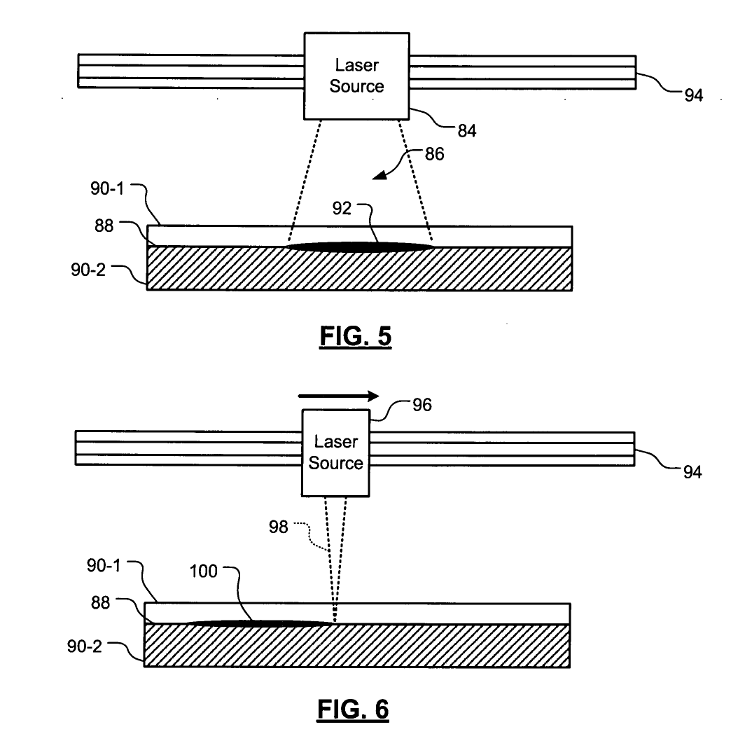

Referring now to FIG. 5, the TTLW process according to the present invention allows for different laser source configurations in order to heat junctions between the plastic enclosure components. In FIG. 5, a laser source 84 utilizes a plurality of laser beams such as a laser array to continuously heat a predefined portion 86 of a junction 88 between the plastic enclosure components 90. The heat generates a melt pool 92 within the predefined region 86. Since the laser source 84 heats an enlarged portion 86 of the junction 88, the laser source 84 typically remains fixed during welding. However, the laser source 84 is also optionally moveable along an optical rail 94.

Referring now to FIG. 6, a laser source 96 moves along the optical rail 94 during welding in order to scan the junction 88 between the plastic enclosure components 90. A laser beam 98 heats the junction 88 as it moves along the optical rail 94, leaving a melt pool 100 path that hardens to structurally bond the plastic enclosure components 90. In an exemplary embodiment, the laser source 96 is capable of moving along the optical rail 94 at high speeds. Therefore, a single focused laser beam 98 is capable of producing a large weld along the junction 88 during a single welding operation.

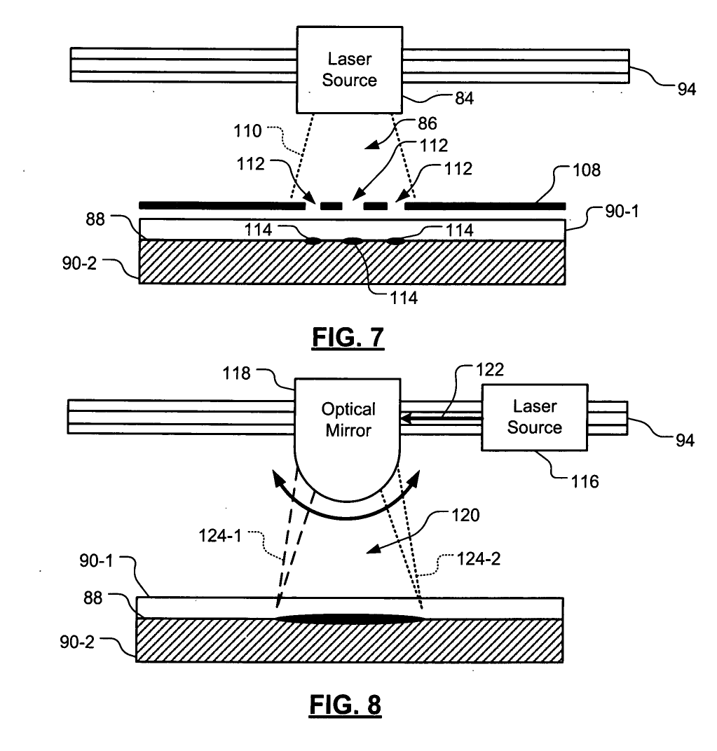

Referring now to FIG. 7, a masking curtain 108 selectively filters a laser beam 110 in order to illuminate disjointed or irregularly shaped portions of the junction 88 between the plastic enclosure components 90. For example, the laser source 84 of FIG. 5 may be utilized to illuminate selected portions of the junction 88. Since the masking curtain 108 is opaque to the wavelength of the laser beam 110, the laser beam 110 only reaches portions of the junction 88 that are exposed by openings 112 in the masking curtain 108. Therefore, the laser source 84 is capable of creating multiple isolated melt pools 114 along the junction 88. For example, the masking curtain 108 may be used to shield portions of the battery module 36 that house heat-sensitive components.

Referring now to FIG. 8, a laser source 116 and an optical mirror 118 are capable of heating a predefined portion 120 of the junction 88 between the plastic enclosure components 90 using quasi-continuous heating. The laser source 116 emits a single laser beam 122, which is received by the optical mirror 118. The optical mirror 118 disperses the laser beam 122 so that a continuous heating pattern is created on the junction 88. Similarly to the effect of a laser array, the optical mirror 118 generates a plurality of individual laser beams 124 that collectively illuminate a predefined area 120.

Through transmission laser welding according to the present invention is utilized to weld plastic enclosure components 90 of battery modules 36 such as battery cells for hybrid electric vehicles. The process is silent and high speed, allowing for high production rates. The plastic enclosure components 90 do not move during the welding process, and the risk of contamination is low since no flash or particulate is generated. Additionally, the process enables precise control of final assembly dimensions.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and the following claims.

What is claimed is:

1. A through transmission laser welding system for a battery module enclosure, comprising:
a first battery module enclosure component;
a second battery module enclosure component that interfaces with said first battery module enclosure component; and
a laser source that focuses a laser beam on a junction between said first and second battery module enclosure components in order to form a weld between said first and second battery module enclosure components.

2. The through transmission laser welding system of claim 1 wherein said first and second battery module enclosure components comprise polymeric thermoplastics.

3. The through transmission laser welding system of claim 1 wherein a wavelength of said laser beam is between 800 nm and 1100 nm.

4. The through transmission laser welding system of claim 1 wherein said first battery module enclosure component is transmissive to a wavelength of said laser beam and said second battery module enclosure component is opaque to a wavelength of said laser beam.

5. The through transmission laser welding system of claim 1 further comprising a laser absorbing coating that is applied at an interface between said first and second battery module enclosure components, wherein both said first and second battery module enclosure components are transmissive to a wavelength of said laser beam.

6. The through transmission laser welding system of claim 1 wherein said laser source includes a plurality of laser sources that are arranged to continuously illuminate a predetermined area of said junction.

7. The through transmission laser welding system of claim 6 further comprising a masking curtain that is located adjacent to said junction and that selectively filters said laser beam.

8. The through transmission laser welding system of claim 1 wherein said laser source includes a single laser source that is scanned across said junction in order to form said weld.

9. The through transmission laser welding system of claim 1 wherein said laser source includes a single laser source and an optical mirror that disperses said laser beam in order to continuously illuminate a predetermined area of said junction.

10. The through transmission laser welding system of claim 9 further comprising a masking curtain that is located adjacent to said junction and that selectively filters said laser beam.

11. The through transmission laser welding system of claim 1 wherein the battery module enclosure houses battery cells for a hybrid electric vehicle.

12. A method for operating a through transmission laser welding system for a battery module enclosure, comprising:
providing a first battery module enclosure component;
providing a second battery module enclosure component;
interfacing said first and second battery module enclosure components;
focusing a laser beam on a junction between said first and second battery module enclosure components; and
forming a weld between said first and second battery module enclosure components at said junction.

13. The method of claim 12 wherein said first and second battery module enclosure components comprise polymeric thermoplastics.

14. The method of claim 12 wherein a wavelength of said laser beam is between 800 nm and 1100 nm.

15. The method of claim 12 wherein said first battery module enclosure component is transmissive to a wavelength of said laser beam and said second battery module enclosure component is opaque to a wavelength of said laser beam.

16. The method of claim 12 further comprising applying a laser absorbing coating at an interface between said first and second battery module enclosure components, wherein both said first and second battery module enclosure components are transmissive to a wavelength of said laser beam.

17. The method of claim 12 further comprising:
generating said laser beam with a plurality of laser sources; and
arranging said plurality of laser sources to continuously illuminate a predetermined area of said junction.

18. The method of claim 17 further comprising:
locating a masking curtain adjacent to said junction; and
selectively filtering said laser beam with said masking curtain.

19. The method of claim 12 further comprising:
generating said laser beam with a single laser source; and
scanning said laser source across said junction in order to form said weld.

20. The method of claim 12 further comprising:
generating said laser beam with a single laser source; and
dispersing said laser beam with an optical mirror in order to continuously illuminate a predetermined area of said junction.

21. The method of claim 20 further comprising:
locating a masking curtain adjacent to said junction; and
selectively filtering said laser beam with said masking curtain.

22. The method of claim 12 further comprising housing battery cells for a hybrid electric vehicle in the battery module enclosure.
